(19) United States
(12) Patent Application Publication
(10) Pub. No.: US 2007/0076353 A1
(43) Pub. Date: Apr. 5, 2007

(54) Panel fixing structure

(75) Inventor: Kuang-Yi Kao, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/311,970

(22) Filed: Dec. 19, 2005

(30) Foreign Application Priority Data
Aug. 8, 2005 (TW) 094213436

(51) Int. Cl. H02B 1/00

(52) U.S. Cl. 361/600

(57) ABSTRACT

A panel fixing structure is proposed, for fixing a panel to an electronic device having fixing sections on two sides thereof respectively. The structure includes two holding members and two side plates. Each of the holding members includes a first fixing portion and at least one coupling portion that is for being coupled to at least one of the fixing sections. The two side plates are provided on two sides of the panel respectively. Each of the side plates includes a second fixing portion for being coupled to the first fixing portion. Therefore, assembly and disassembly of a panel for the electronic device can be performed by means of the panel fixing structure without using any tool.

### BACKGROUND OF THE INVENTION

1. Field of the Invention

The present invention relates to panel fixing structures, and more particularly, to a panel fixing structure for fixing a panel to an electronic device.

2. Description of the Background Art

A common structural design of an electronic device, such as a server, a computer or the like includes a housing or panel to protect inner circuit components or mechanism components of the electronic device from damage or dust and provide a desirable appearance of the electronic device. For example of the server, there are provided fixing sections such as handles on two sides thereof to facilitate maintenance, testing or manipulation of the server.

Generally the panel is assembled and fixed to the electronic device by means of screws, and is locked to the electronic device by inserting a locking member with a locking piece into the panel. The related patent includes Taiwanese Utility Model Patent No. M248203.

The Taiwan Patent No. M248203 discloses a structure for quick disassembly of a panel from an electrical device. The structure comprises a fixing plate fixed to two sides of the electrical device by bolts; a pair of wing plates formed at two sides of the panel; a central post penetrating and fixed in a through hole of each of the wing plates, wherein the central post is tubular and a head portion thereof is hunched to form a blocking portion; and a nut capable of being movably coupled to an end of the central post not having the blocking portion, and having an inner screw hole such that the nut can be screwed to a thread portion of each of the bolts via the inner screw hole, so as to assemble the panel to the electrical device. The nut is formed with an inner movement space, wherein one end of the space is an open end, and the other end of the space has a central screw hole corresponding in diameter and length of the thread portion of each of the bolts.

However, by the above fixing method using the screws, auxiliary tools are required for disassembly and assembly of the panel from and to the electronic device, thereby causing inconvenience and constraint on operation. For example, the panel is usually disassembled from the electronic device when a plurality of modules are to be assembled to form a combined device; and after the combined device is formed, the panel is assembled back to the device.

Taking the server as an example, the server is a combination of a plurality of machine units installed in a cabinet, and as the machine units are often subjected to replacement or maintenance, the panel screwed to the front of the cabinet should accordingly be disassembled and assembled. However, the screws for assembling the panel to the server may easily drop into the cabinet or become lost due to the limited surrounding space. This makes the disassembly and assembly process not performed efficiently, causes a waste of time and increases the extra cost for screws.

In addition, there is no panel fixing technology for disassembling and assembling the panel without the use of auxiliary tools and without altering the inherent components or design of the electronic device. Therefore, the problem to be solved here is to provide a panel fixing structure, which allows assembly and disassembly of the panel to be quickly and conveniently performed without using any tool, so as to improve the efficiency and convenience of the assembly and disassembly process.

### SUMMARY OF THE INVENTION

In light of the foregoing drawbacks of the prior art, it is an objective of the present invention to provide a panel fixing structure, which allows a panel to be assembled to or disassembled from an electronic device without the use of any tool.

It is another objective of the present invention to provide a panel fixing structure, which allows assembly and disassembly of the panel to be quickly and conveniently performed.

It is a further objective of the present invention to provide a panel fixing structure without having to alter inherent components or design of the electronic device.

In order to achieve the above and other objectives, the present invention proposes a panel fixing structure applicable in an electronic device, for fixing a panel to the electronic device, the electronic device having fixing sections provided on two sides thereof respectively. The panel fixing structure includes two holding members and two side plates. Each of the holding members includes a first fixing portion and at least one coupling portion that is capable of being coupled to at least one of the fixing sections of the electronic device. The two side plates are provided on two sides of the panel respectively. Each of the side plates includes a second fixing portion that can be coupled to the first fixing portion.

Preferably, the coupling portion is a coupling ring such as a C-shaped coupling ring. The first fixing portion is a recessed portion. Each of the holding members further comprises a blocking portion that can be provided aside the coupling portion. At least one of the two holding members further comprises a first locking portion, wherein the first locking portion can be an opening.

The second fixing portion of each of the two side plates has a protuberant structure. Preferably, the protuberant structure is a protruding block or a protruding rib. The protuberant structure of the second fixing portion of one of the side plates can be a right-angled protuberant structure or a hook structure, and the protuberant structure of the second fixing portion of the other side plate can be a structure having a round chamfer or an arc structure, so as to facilitate assembly/disassembly of the panel to/from the electronic device.

Each of the side plates further comprises two third fixing portions for fixing two sides of each of the holding members respectively and at least one flexible portion provided between the third fixing portions. Preferably, each of the third fixing portions has a protruding structure vertically protruded from a surface of the corresponding side plate and for engagement with the side of the corresponding holding member. The flexible portion can comprise a notch. At least one of the two side plates further comprises a second locking portion, wherein the second locking portion can be an opening corresponding to the first locking portion.

By the use of the panel fixing structure of the present invention, assembly and disassembly of the panel to and from the electronic device can be performed without any tool, thereby overcoming the prior-art drawbacks such as inconvenience in operation caused by using screws to fix the panel to the electronic device and the need of auxiliary tools for assembly and disassembly of the panel, such that the present invention can avoid prior-art problems such that loss of screws, inefficient assembly and disassembly, waste of time and increase in cost for screws.

Moreover, as disassembly and assembly of the panel are performed without any tool when using the panel fixing structure of the present invention, the assembly and disassembly process can be quickly and conveniently implemented. Further, the use of the panel fixing structure of the present invention does not alter inherent components or design of the electronic device. Therefore, the present invention improves the convenience and efficiency of assembling or disassembling the panel to or from the electronic device, such that the panel fixing structure of the present invention can be widely applied to current electronic products.

### BRIEF DESCRIPTION OF THE DRAWINGS

The present invention can be more fully understood by reading the following detailed description of the preferred embodiments, with reference made to the accompanying drawings, wherein:

FIG. 1 is a right-side structural schematic diagram of a panel mounted with a panel fixing structure according to a preferred embodiment of the present invention;

FIG. 2 is a left-side structural schematic diagram of the panel mounted with the panel fixing structure according to the preferred embodiment of the present invention;

FIG. 3 is an exploded schematic diagram of the panel fixing structure according to the present invention applied to assembling the panel to an electronic device; and

FIGS. 4A to 4G are schematic diagrams of steps of assembling the panel to the electronic device by means of the panel fixing structure according to the present invention.

### DETAILED DESCRIPTION OF THE PREFERRED EMBODIMENTS

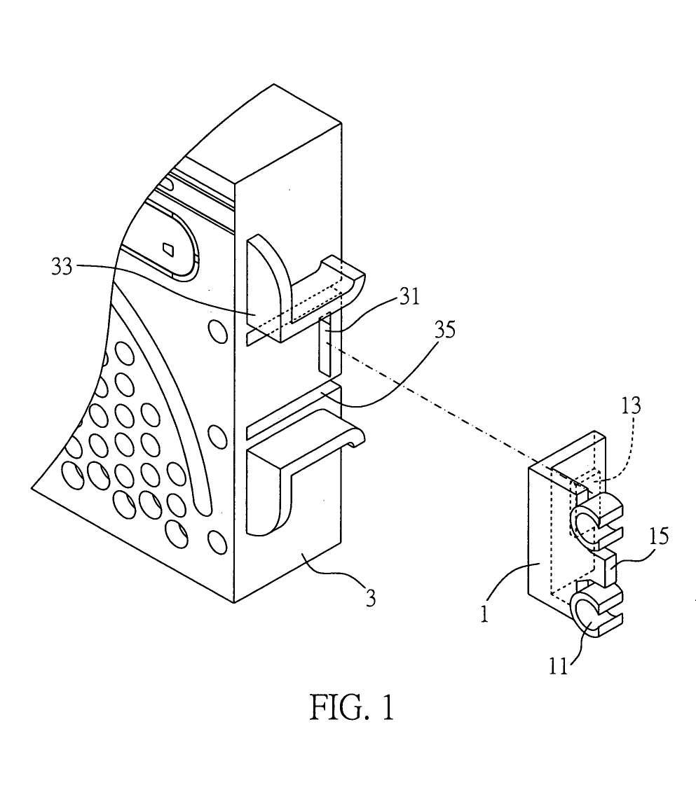

FIGS. 1 to 4G are schematic diagrams of a panel fixing structure according to a preferred embodiment of the present invention. It should be noted that the panel fixing structure is used to fix a panel to an electronic device. The electronic device can be, but not limited to, a server, and other conventional electronic devices are also suitably used in the present invention. Since the structure of the electronic device would not be changed in the present invention, only the part of structure of the electronic device directly relating to the present invention is shown in the drawings for the sake of simplicity.

Moreover, the drawings are all simplified schematic diagrams and merely show the components or elements relating to the present invention. It should be understood that the arrangement of components or elements could be more complex in practice.

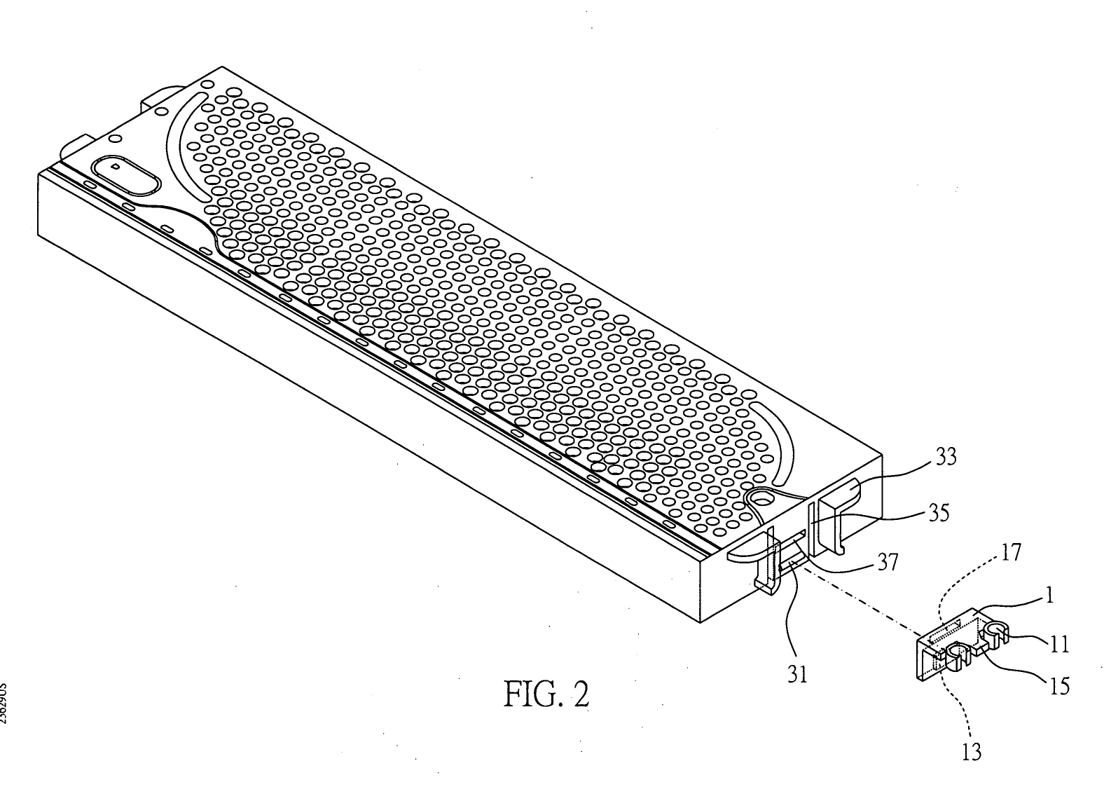

As shown in FIGS. 1 and 2, the panel fixing structure in this embodiment of the present invention comprises two holding members 1 and two side plates 3. The two holding members 1 are similar in structure to each other, and the two side plates 3 are also similar in structure to each other.

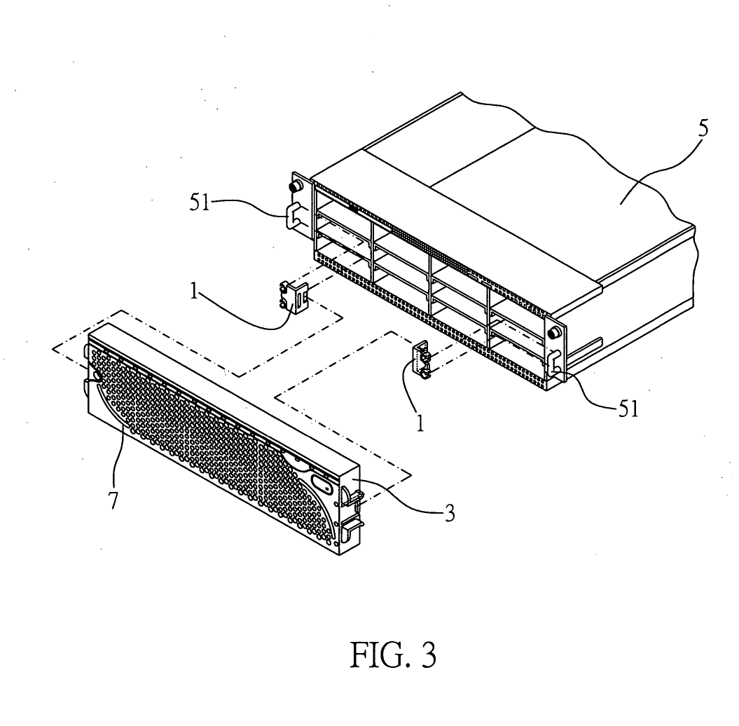

As shown in FIG. 3, the panel fixing structure is applied in an electronic device 5, and is used to fix and assemble a panel 7 to the electronic device 5. The electronic device 5 is formed with fixing sections 51 such as handles on two sides thereof respectively.

Referring to FIGS. 1 and 3, for fixing and assembling a right side of the panel 7 to the electronic device 5, one of the two holding members 1 of the panel fixing structure is coupled to the fixing section 51 at the right side of the electronic device 5, wherein the holding member 1 comprises at least one coupling portion 11 coupled to the fixing section 51, a first fixing portion 13, and a blocking portion 15. In this embodiment, the coupling portion 11 can be a coupling ring such as a C-shaped coupling ring or any other equivalent structure capable of being coupled to the fixing section 51. The first fixing portion 13 can be a recessed portion, and the blocking portion 15 is provided aside the coupling portion 11 and extended to be inserted into the fixing section 51. One of the two side plates 3 is provided on the right side of the panel 7. The side plate 3 comprises a second fixing portion 31 for being coupled to the first fixing portion 13, two third fixing portions 33 for fixing two sides of the holding member 1 respectively, and at least one flexible portion 35 provided between the third fixing portions 33. In this embodiment, the second fixing portion 31 can have a protuberant structure such as a protruding block, a protruding rib or any other equivalent structure, and the second fixing portion 31 can be a right-angled protuberant structure or a hook structure for the side plate 3 on the right side of the panel 7. Each of the third fixing portions 33 can be a protruding structure vertically protruded from a surface of the side plate 3 and for engagement with the corresponding side of the holding member 1. The flexible portion 35 can comprise a notch.

Referring to FIGS. 2 and 3, for fixing and assembling a left side of the panel 7 to the electronic device 5, the other one of the two holding members 1 of the panel fixing structure is coupled to the fixing section 51 at the left side of the electronic device 5, wherein the holding member 1 comprises at least one coupling portion 11 coupled to the fixing section 51, a first fixing portion 13, a blocking portion 15, and a first locking portion 17. In this embodiment, the first locking portion 17 can be an opening. The other one of the two side plates 3 is provided on the left side of the panel 7. The side plate 3 comprises a second fixing portion 31 for being coupled to the first fixing portion 13, two third fixing portions 33 for fixing two sides of the holding member 1 respectively, at least one flexible portion 35 provided between the third fixing portions 33, and a second locking portion 37, wherein the second locking portion 37 can be an opening corresponding to the first locking portion 17. In this embodiment, the second fixing portion 31 can have a protuberant structure such as a structure having a round chamfer or an arc structure for the side plate 3 on the left side of the panel 7, which is different from the structure of the second fixing portion 31 of the side plate 3 provided on the right side of the panel 7. This arrangement can facilitate assembly and disassembly of the panel 7 to and from the electronic device 5, which is described hereinafter.

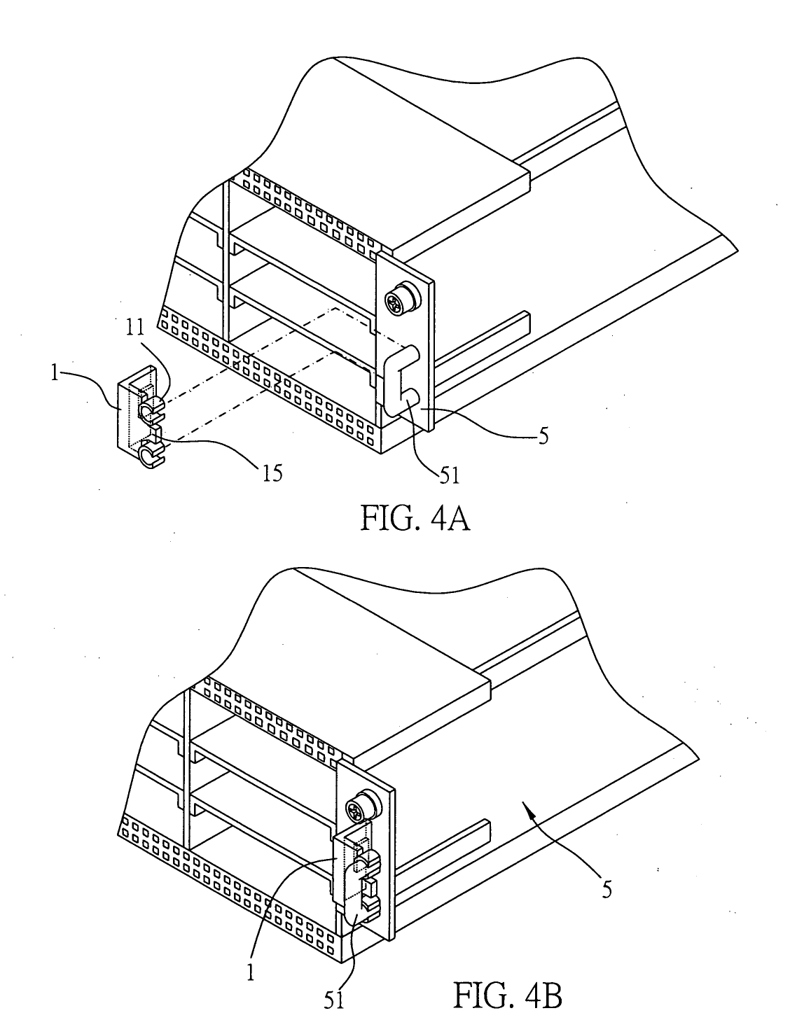

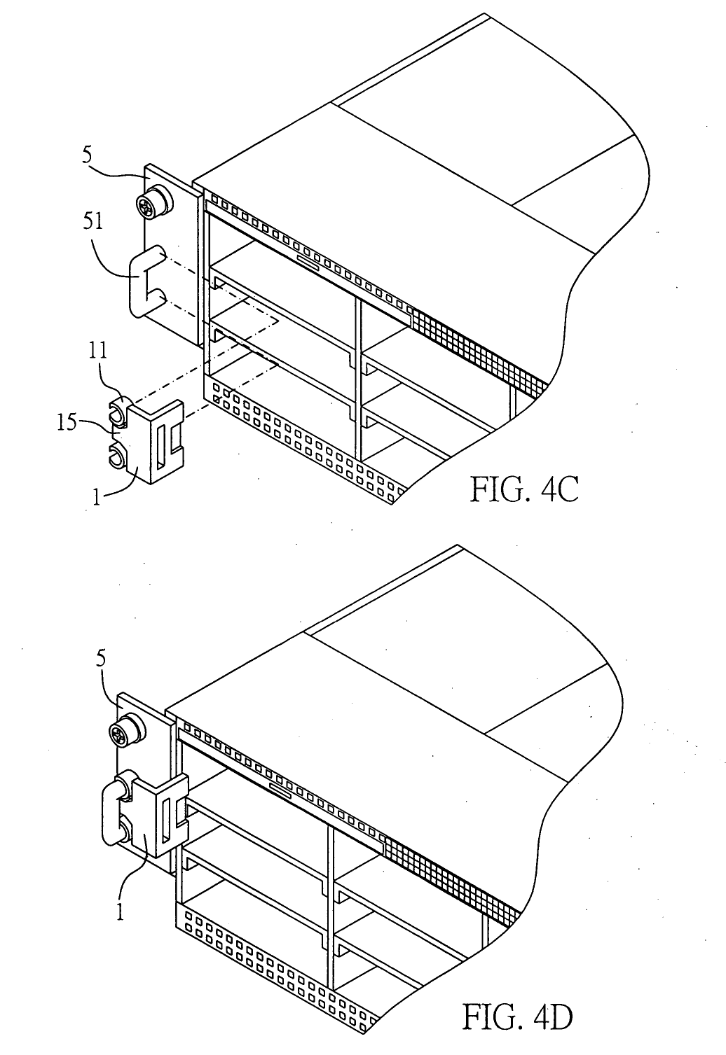

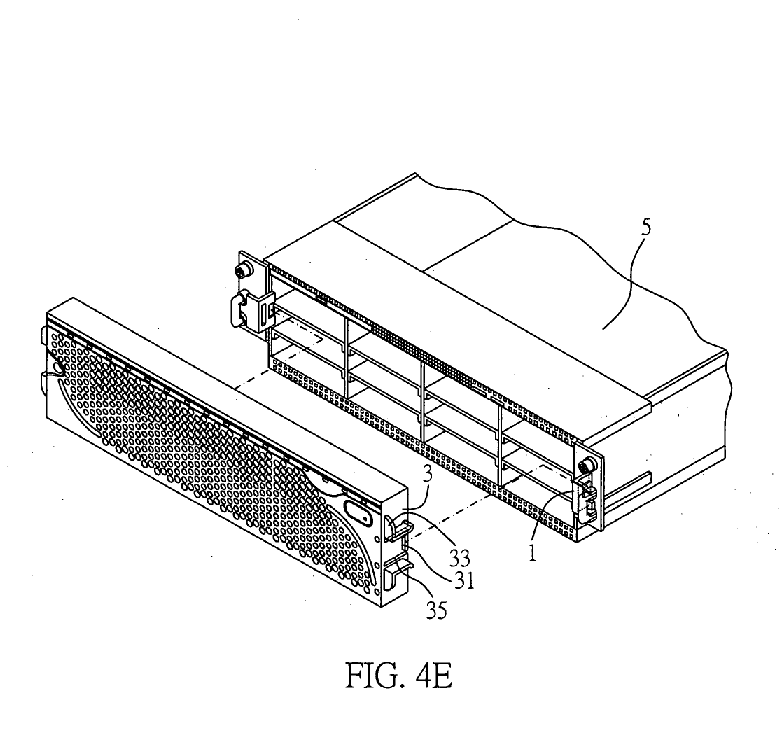

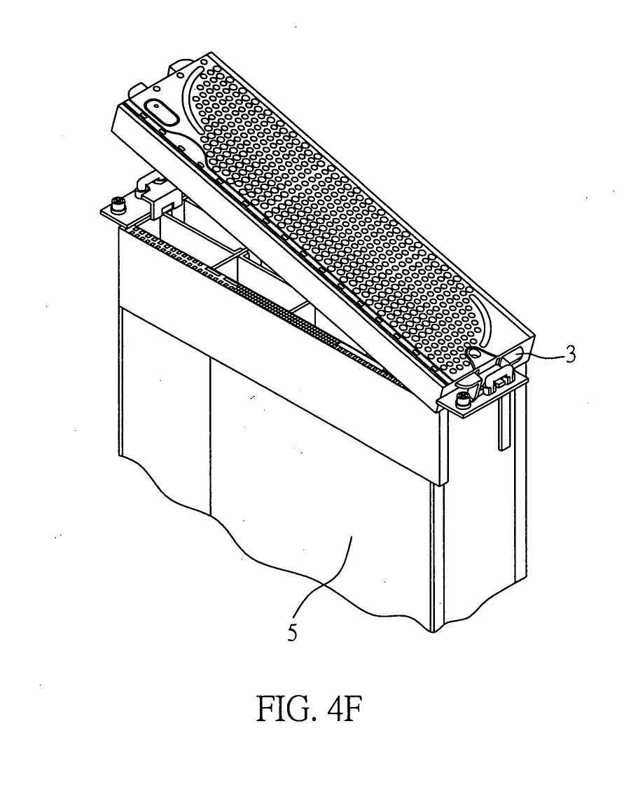

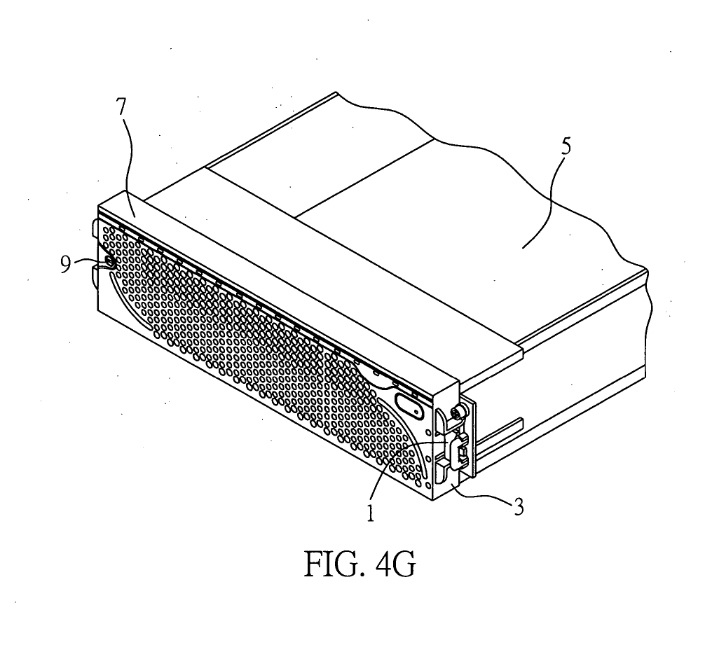

Before fixing and assembling the panel 7 to the electronic device 5, the two holding members 1 are coupled to the two sides of the electronic device 5 respectively. As shown in FIG. 4A, the coupling portion 11 of one of the two holding members 1 of the panel fixing structure is coupled to the fixing section 51 at the right side of the electronic device 5, and the blocking portion 15 is inserted into the fixing section 51, such that the holding member 1 is mounted to the right side of the electronic device 5 as shown in FIG. 4B. As shown in FIG. 4C, the coupling portion 11 of the other one of the two holding members 1 is coupled to the fixing section 51 at the left side of the electronic device 5, and the blocking portion 15 is inserted into the fixing section 51, such that the holding member 1 is mounted to the left side of the electronic device 5 as shown in FIG. 4D.

As shown in FIG. 4E, one of the two side plates 3 of the panel fixing structure is mounted to the right side of the panel 7, and the second fixing portion 31 of the side plate 3 is coupled to the first fixing portion 13 of the holding member 1 mounted to the right side of the electronic device 5, wherein the third fixing portions 33 of the side plate 3 fix two sides of the holding member 1. If there is any fabrication inaccuracy making the third fixing portions 33 not easy to fix the two sides of the holding member 1, the flexible portion 35 between the third fixing portions 33 can provide flexibility for the third fixing portions 33 to be properly extended to fix the holding member 1 between the third fixing portions 33. As shown in FIG. 4F, the other one of the two side plates 3 is mounted to the left side of the panel 7. The second fixing portion 31 of the side plate 3 on the left side of the panel 7 can be a protuberant structure having a round chamfer or an arc protuberant structure, which is easier to be coupled to the first fixing portion 13 of the holding member 1 on the left side of the electronic device 5 as compared to coupling the second fixing portion 31 (such as a right-angled protuberant structure or a hook protuberant structure) of the side plate 3 on the right side of the panel 7 to the first fixing portion 13 of the holding member 1 on the right side of the electronic device 5. Thereby, when one of the side plates 3 of the panel fixing structure has been coupled to the holding member 1 on the right side of the electronic device 5, the structure of the second fixing portion 31 (such as a protuberant structure having a round chamfer or an arc protuberant structure) allows the other one of the side plates 3 to be easily assembled to the holding member 1 on the left side of the electronic device 5 without using any auxiliary tool. After the two side plates 3 are both coupled to the holding members 1 on the electronic device 5, as shown in FIG. 4G, a conventional locking member 9 with a locking piece is used to lock the panel 7 to the electronic device 5, wherein the locking member 9 penetrates the panel 7, and the locking piece of the locking member 9 penetrates the first locking portion 17 and the second locking portion 37 of the panel fixing structure. The structure and function of the conventional locking member 9 and its locking piece are well known in the art and not be further described herein.

Accordingly, by coupling the side plates 3 mounted on the panel 7 to the holding members 1 mounted on the electronic device 5, the panel 7 can be fixed and assembled to the electronic device 5 by means of the panel fixing structure of the present invention.

If the panel 7 is to be disassembled from the electronic device 5, firstly, the locking member 9 can be removed, and then the side plates 3 on the panel 7 can be respectively uncoupled from the holding members 1 on the left and right sides of the electronic device 5, without using any auxiliary tool to perform disassembly of the panel 7 from the electronic device 5. As the second fixing portion 31 (such as a protuberant structure having a round chamfer or an arc protuberant structure) of the side plate 3 on the left side of the panel 7 is easier to be uncoupled from the corresponding first fixing portion 11 of the holding member 1 than the second fixing portion 31 (such as a right-angled protuberant structure or a hook protuberant structure) of the side plate 3 on the right side of the panel 7, it is preferable to firstly disassemble the side plate 3 on the left side of the panel 7 from the electronic device 5 and then disassemble the side plate 3 on the right side of the panel 7 from the electronic device 5.

It should be understood that the present invention is not limited to the foregoing sequence of steps of assembly or disassembly of the panel 7 through the use of the panel fixing structure, and the sequence of assembly or disassembly steps can be changed or reversed if necessary. For example, if the second fixing portion 31 of the side plate 3 on the left side of the panel 7 has a right-angled protuberant structure or a hook protuberant structure, and the second fixing portion 31 of the side plate 3 on the right side of the panel 7 has a protuberant structure having a round chamfer or an arc protuberant structure, it may firstly assemble/disassemble the side plate 3 on the right side of the panel 7 to/from the electronic device 5 and then assemble/disassemble the side plate 3 on the left side of the panel 7 to/from the electronic device 5, as long as the assembly/disassembly process is efficient and time-effective for a user to implement. Moreover, it is also able to exchange the structure of the holding member 1/side plate 3 on the right side with that of the holding member 1/side plate 3 on the left side, or make the structures of the holding members 1/side plates 3 on both the left and right sides identical; these modifications are easily accomplished by a person skilled in the art and not to be further detailed here.

Compared to the prior art using screws to assemble the panel to the electronic device and causing various drawbacks, the present invention allows disassembly and assembly of the panel to/from the electronic device to be performed by means of the panel fixing structure without any tool, such that the assembly and disassembly process can be quickly and conveniently implemented. Further, the use of the panel fixing structure of the present invention can assemble the panel to the current structure of the electronic device, without altering inherent components or design of the electronic device. Therefore, the present invention improves the convenience and efficiency of assembling or disassembling the panel to or from the electronic device, such that the panel fixing structure of the present invention can be widely applied to current electronic products, and the various drawbacks of the prior art are overcome by the present invention.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A panel fixing structure for fixing a panel to an electronic device, the electronic device having fixing sections provided on two sides thereof respectively, the panel fixing structure comprising:
two holding members, each of which comprises a first fixing portion and at least one coupling portion for being coupled to at least one of the fixing sections; and
two side plates provided on two sides of the panel respectively, wherein each of the two side plates comprises a second fixing portion for being coupled to the first fixing portion.

2. The panel fixing structure of claim 1, wherein the coupling portion is a coupling ring.

3. The panel fixing structure of claim 2, wherein the coupling ring has a C shape.

4. The panel fixing structure of claim 1, wherein the first fixing portion is a recessed portion.

5. The panel fixing structure of claim 1, wherein each of the holding members further comprises a blocking portion.

6. The panel fixing structure of claim 5, wherein the blocking portion is provided aside the coupling portion.

7. The panel fixing structure of claim 1, wherein at least one of the two holding members further comprises a first locking portion.

8. The panel fixing structure of claim 7, wherein the first locking portion is an opening.

9. The panel fixing structure of claim 1, wherein the second fixing portion has a protuberant structure.

10. The panel fixing structure of claim 9, wherein the protuberant structure is one of a protruding block and a protruding rib.

11. The panel fixing structure of claim 9, wherein the protuberant structure is one of a right-angled protuberant structure and a hook structure.

12. The panel fixing structure of claim 9, wherein the protuberant structure is one of a structure having a round chamfer and an arc structure.

13. The panel fixing structure of claim 1, wherein each of the side plates further comprises:
two third fixing portions for fixing two sides of each of the holding members respectively; and
at least one flexible portion provided between the two third fixing portions.

14. The panel fixing structure of claim 13, wherein each of the third fixing portions has a protruding structure.

15. The panel fixing structure of claim 13, wherein the flexible portion comprises a notch.

16. The panel fixing structure of claim 1, wherein at least one of the two side plates further comprises a second locking portion.

17. The panel fixing structure of claim 16, wherein the second locking portion is an opening.
